(19) United States
(12) Patent Application Publication
(10) Pub. No.: US 2010/0050405 A1
(43) Pub. Date: Mar. 4, 2010

(54) DEVICE FOR PRECISION MACHINING OR MICROMACHINING WORKPIECES

(75) Inventor: Simon Wolber, Wolfach (DE)

Correspondence Address: Brinks Hofer Gilson & Lione/Ann Arbor, 524 South Main Street, Suite 200, Ann Arbor, MI, 48104, US

(73) Assignee: Supfina Grieshaber GmbH & Co. KG, Wolfach (DE)

(21) Appl. No.: 12/540,918

(22) Filed: Aug. 13, 2009

Related U.S. Application Data
(60) Provisional application No. 61/092,751, filed on Aug. 29, 2008.

(51) Int. Cl. B23Q 5/22; B23Q 5/28

(52) U.S. Cl. 29/33 R; 29/561

(57) ABSTRACT

The disclosure relates to a device for precision machining or micromachining workpieces, with a feed mechanism for transporting at least one workpiece, with a storage device, which includes a magazine for storing at least one workpiece, and with a tool for machining at least one workpiece, wherein the at least one workpiece can be led out of the magazine of the storage device to the feed mechanism, wherein the feed mechanism can be moved such that a workpiece held on the feed mechanism can be transported to the tool, wherein the magazine of the storage device can be moved along a magazine motion path, whose course is aligned at least in part with a workpiece motion path, which is traversed by a workpiece held on the feed mechanism during the transport from the magazine of the storage device to the tool.

### CROSS-REFERENCE TO RELATED APPLICATIONS

This application claims the benefit of provisional Application No. 61/092,751, filed on Aug. 29, 2008, the contents of which are incorporated herein by reference in their entirety.

### FIELD

The present disclosure relates to a device for precision machining or micromachining workpieces.

### BACKGROUND

Devices for precision machining workpieces are known, however, devices that allow a particularly reliable transfer of the workpieces from a magazine to a feed mechanism are desirable for improved manufacturing efficiencies.

### SUMMARY

The present disclosure relates to a device for precision machining or micromachining workpieces, with a feed mechanism for transporting at least one workpiece, with a storage device, which comprises a magazine for storing at least one workpiece, and with a tool for processing at least one workpiece, wherein the at least one workpiece can be led out of the storage device magazine to the feed mechanism, wherein the feed mechanism can be moved such that a workpiece held on the feed mechanism can be transported to the tool.

A device of this type allows to store at least one workpiece in a position at a distance from the tool and to feed this workpiece from there to the tool with the aid of the feed mechanism. By spatially decoupling the tool and the workpiece stock, it is possible to refill the magazine of the storage device with further workpieces, without disturbing a machining process by the tool on a workpiece. Thus, the device may at least be largely operated without interruption.

Further provided herein is a device for precision machining or micromachining workpieces of the above mentioned type, in which the magazine of the storage device can be moved along a magazine motion path whose course is aligned with at least one part of a workpiece motion path which is traversed by a workpiece held on the feed mechanism during transport from the storage device magazine to the tool.

The mobility of the storage device magazine in a manner synchronized with the motion of a workpiece held on the feed mechanism allows synchronous movement of the magazine and a workpiece held on the feed mechanism together. Thus, a workpiece which has not completely been led out of the storage device magazine to the feed mechanism can not only move together with the feed mechanism, but also together with the storage device magazine. During the motion of the workpiece in a synchronous manner to the feed mechanism, a workpiece which is still partially engaged with the magazine can move along accordingly. A relative movement between the storage device magazine, the still-not-completely-transferred workpiece and the feed mechanism is prevented in this way. The destruction of the storage device magazine and/or of a workpiece to be transferred and/or of the feed mechanism may thus be prevented. A workpiece can be entirely delivered to the feed mechanism during the combined motion of the storage device magazine, the workpiece and the feed mechanism, so that it is disengaged from the storage device magazine. This has the advantage that the feed mechanism must not be stopped, so that the delivery of the workpiece in the direction of the tool does not have to be interrupted. The transfer time of the device according to the present disclosure is increased in this way. In case a workpiece cannot be transferred into or onto the feed mechanism even during the combined motion of the storage device magazine, the workpiece and the feed mechanism, as a result of, for example, the workpiece having become permanently jammed, a stopping distance for holding the feed mechanism, which corresponds to at least one length of the magazine motion path, is available. Thus, the feed mechanism need not be abruptly stopped.

Within the scope of the present disclosure, the magazine cannot only be moved along the magazine motion path, but also in directions that are transverse thereto. However, it is advantageous that the magazine of the storage device can at least move such that it can follow the movement of the workpiece along at least part of the workpiece motion path.

The magazine motion path and the workpiece motion path in particular have at least approximately parallel direction components. Along direction components parallel to one another, the mobility of the magazine is thus adapted to the motion of the workpiece along the workpiece motion path. Additional mobility can be provided in transverse directions to the components parallel to one another, for example, by moving the storage device magazine together with the feed mechanism such that the distance between the storage device magazine and the feed mechanism is increased.

It is advantageous if the magazine motion path and the workpiece motion path run at least approximately parallel to one another other, or exactly parallel to one other. In this way, the transfer time available for transferring the workpiece out of the storage device magazine into or onto the feed mechanism is extended. The spatial relationship between the storage device magazine and the feed mechanism during the joint motion of the storage device magazine and the feed mechanism remains unchanged in this way.

The present disclosure further provides that the magazine motion path and the workpiece motion path are curved. This allows for a space-saving arrangement of the storage device, the feed mechanism and the tool of the device.

The present disclosure further provides that the magazine motion path and the workpiece motion path run respectively along a circular arc.

It is further provided that the magazine motion path and the workpiece motion path have a common center of curvature. For example, the two motion paths can overlap within an angular sector of approximately 5° to approximately 50°, or approximately 20° to approximately 35°. The storage device magazine can move within this angular sector around the same center of curvature as a workpiece held on the feed mechanism.

A guiding mechanism for guiding the magazine along the magazine motion path is also provided. A guiding mechanism of this type allows an exact specification of the magazine motion path. The guidance of the magazine along an arc-shaped, or a circular arc-shaped section, for example, may be achieved by means, for example of a guiding device.

The device further comprises an adjusting mechanism for adjusting the position of the magazine relative to the feed mechanism. The motion paths of the magazine and a workpiece held on the feed mechanism can be exactly aligned relative to one other in this way. This may be advantageous if the device can be operated by feed mechanisms, which are different from one another with regard to their size and/or design and/or if differently dimensioned workpieces are to be machined.

The feed mechanism may be configured in the shape of a feed plate. A feed plate of this type this allows the specification of a circular arc-shaped workpiece motion path. A feed plate likewise provides several holding areas or receiving areas, so that several workpieces can be transported at the same time.

The present disclosure further provides that the at least one tool of the device is a grinding tool or a machining tool. In this connection, the workpieces held by the feed mechanism can be fed to a grinding or machining tool, and be machined and led away again. The feed mechanism can thus continuously move and receive new workpieces from the storage device magazine during this motion.

The tool may be a surface grinding tool, which has an effective surface that is parallel to a plane of motion of the feed mechanism.

Tool(s) may be arranged on both sides of the feed mechanism, so that simultaneous machining in particular of mutually opposite surfaces of the workpiece is possible, for example, within a double face grinding process.

The loading mechanism of a workpiece may run transversely from the magazine to the feed mechanism, or vertically, to the workpiece motion path. This allows simple loading of a workpiece from the magazine in the direction of the feed mechanism. It is possible to store several workpieces in the magazine, which together form a stack of workpieces.

The loading mechanism from the magazine to the feed mechanism can run at least approximately vertical to the direction of the force of gravity, so that the workpiece can be transferred from the magazine to the feed mechanism by means of the force of gravity, so that a workpiece falls from the magazine by its own weight and is guided in the feeding direction.

The storage device can be moved between a home position and an end position. The specification of the home position allows for simple and automated loading of the workpieces to be processed from an external reservoir into the storage device magazine. The specification of the home position makes possible, in addition, definition of a position of the storage device, in which the transfer of a workpiece from the magazine to the feed mechanism is to be carried out during normal operation of the device. The specification of an end position allows limiting the range of motion of the storage device, so that a collision with other components of the device can be precluded.

Further, if a fixing mechanism is provided, by means of which the storage device can be fixed detachable in the home position. In this way, it is ensured that the storage device remains in its home position, insofar as jamming of the workpiece between the magazine and the feed mechanism does not exceed a release resistance of the fixing mechanism. The fixing mechanism is formed, for example, by a locking mechanism, which comprises in particular a spring-loaded sphere.

The release resistance of the fixing mechanism can be adjusted in an advantageous manner. For the example of a spring-loaded sphere, the pretension of the spring can be changed so that the desired release resistance of the locking mechanism can be preset.

A forward drive mechanism for driving the storage device in the direction of the end position is also provided. A forward drive mechanism of this type allows acceleration of the storage device after leaving the home position, whereby the release of the workpiece from the magazine is supported. In the simplest case, the forward drive mechanism is formed by a preloaded spring. If the device comprises a previously described fixing mechanism with an adjustable release resistance, it is possible to accordingly increase the release resistance of the tension load of a forward drive mechanism.

In order to support the release of the workpiece from the magazine, it is possible to alternatively or additionally provide an impulse generator, which generates a mechanical impulse on the workpiece and/or the storage device magazine. The latter is in the simplest case a plunger, for example, which can be pneumatically actuated. A impulse generator can generate a simple impact on the workpiece and/or magazine and/or can cause the magazine to vibrate.

A reverse drive mechanism for driving the storage device is provided in the direction of the home position. This allows transfer of the storage device from a position different from the ground position back to the ground position. The reverse drive mechanism can be configured, for example, in the form of a recuperating spring. In addition or as an alternative thereto, it is possible to provide a motor drive.

The device may comprise a detection device for detecting a position and/or a movement of the storage device. Switches and/or sensors can be utilized for this purpose, with which it can be detected, for example, if the storage device is in the home position, an intermediate position, or an end position.

The detection device for detecting a position and/or a movement of the storage device can be coupled to a control device for controlling the drive of the feed mechanism, so that the drive of the feed mechanism can be automatically switched off, if required. This can be associated with, for example, the detection of the storage mechanism in an intermediate position, so that the storage mechanism can be stopped within a stopping distance, whose end is defined by the end position of the storage device.

Further characteristics and advantages of the disclosure are the subject matter of the following description and the graphic representation of a preferred exemplary embodiment.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a top view of an aspect of a device for precision machining or micromachining workpieces with a tool, a feed mechanism, and a storage device;

FIG. 2 shows a perspective view of the storage device of the device according to FIG. 1; and

FIG. 3 shows a top view of a guiding mechanism of the storage device according to FIG. 2.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

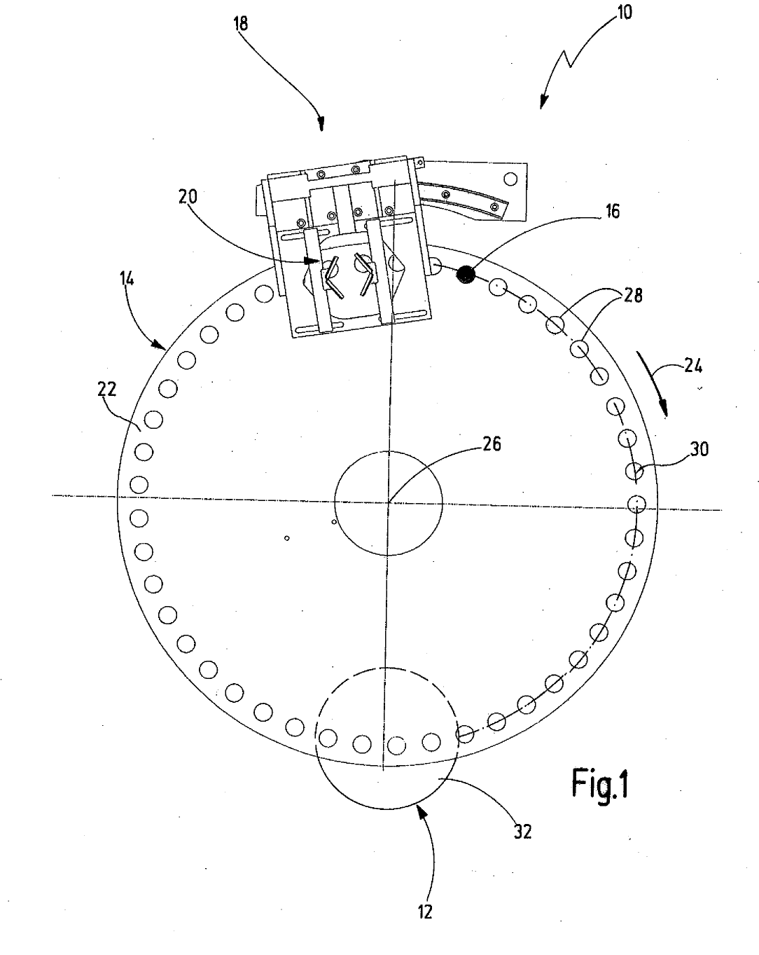

An exemplary form of a device for precision machining or micromachining workpieces entirely designated with reference numeral 10 in FIG. 1 has a tool 12. The device 10 also comprises a feed mechanism 14, by means of which a workpiece 16, which is illustrated schematically in the drawing, can be fed to the tool 12. The device 10 further comprises a storage device 18 with a magazine 20 for storing workpieces 16.

The feed mechanism 14 is formed by a feed plate 22, which can be rotatably driven rotating in a driving direction 24 around a center point 26.

The feed mechanism 14 has several holding areas 28 which serve for holding a workpiece 16 on the feed mechanism 14. The holding areas are firmly connected to the feed mechanism 14 or are an integral component of the feed mechanism 14. The holding areas 28 are formed, for example, by recesses or cavities configured on or in the feed mechanism. As the workpiece 16 held in the holding area 28 is fed, it moves along a curved workpiece motion path 30 around the center point 26.

The tool 12 of the device 10 is configured, for example, as a grinding tool 32 or as a machining tool. A disk-shaped grinding or machining tool, which is arranged—as shown in FIG. 1—in a mutually overlapping arrangement with the feed mechanism 14, allows the surface grinding procedure of a workpiece 16. It is possible that two grinding or machining tools 32 are provided, which are arranged on both sides of the feed mechanism 14, that is, for example, below or above the feed mechanism 14 relative to the direction of the force of gravity.

The magazine 20 of the storage device 18 has a magazine chamber 34, in which several workpieces 16 can be arranged one on top of the other along a stack axis 36. The stack axis 36 runs in vertical direction relative to the direction of the force of gravity.

The magazine chamber 34 is delimited by the magazine walls 38, 40, which extend parallel to the stack axis 36.

The magazine 20 has funnel-shaped guiding sections 42, which can be configured, for example, one-piece with the magazine walls 38, 40 in order to facilitate the insertion of workpieces 16 into the magazine chamber 34.

The magazine walls 38, 40 are in turn held on the magazine holders 44, 46.

The storage device 18 has a frame entirely designated with the reference numeral 48. The magazine holders 44, 46 are each connected with the frame 48 of the storage device 18 by a connecting device 49, 50. The connecting devices 49, 50 are configured, for example, in the form of T-groove connections, which allow the adjustability of a distance of the magazine holder 44, 46 and thus of a distance of the magazine walls 38, 40. The distance 52 of the magazine walls 38, 40 can be adjustable, for example, parallel or in the tangential direction relative to the workpiece motion path 30, so that differently large workpieces 16 can be accommodated in the magazine chamber 34.

The frame 48 is guided by means of a guiding mechanism 54 on a fixed carrier 56 of the device 10. The guiding mechanism 54 comprises a guiding rail 58 curved along a circular arc, which is connected to the carrier 56. The guiding mechanism 54 in addition comprises a guiding element 60 connected to the frame 48 of the storage device 18. The storage device 18 comprises, for example, two guiding elements 60. A guiding element 60 is in particular configured in the shape of a slide shoe.

The at least one guiding element 60 is connected to a base element 62 of the frame 48. The base element 62 has guiding tracks 64, which run transversely to the workpiece motion path 30. A frame element 66 of the frame 48 is displaceably mounted on the guiding tracks 64 of the base element 62. In this way, the frame element 66 can be displaced in a transverse direction 68, in particular vertical direction, to the workpiece motion path 30. The base element 62 and the frame element 66 can be fixed to one another, for example, with by means of clamping elements, screws or threaded pins, which are not shown for the sake of clarity.

Two frame parts 70 are displaceably mounted on the frame element 66. The relative position between the frame element 66 and the frame parts 70 can be adjusted in vertical direction 72. The vertical direction 72 runs parallel to the stack axis 36 of the magazine 20. The frame element 66 and the frame parts 70 can be fixed to one another, for example, by means of clamping elements, screws or threaded pins, which are not shown for the sake of clarity.

The frame parts 70 are connected to a frame plate 74, which can also be an integral part of the frame plates 70. The magazine holders 44, 46 can be mounted adjustably on the frame plate 74 in the aforementioned way.

The base element 62, the frame element 66, and the frame parts 70 form an adjusting mechanism 76, by means of which the position of the magazine 20 can be adjusted relative to the feed mechanism 14. An adjustment in vertical direction 72 can cause the distance of the magazine 20 to the stack axis 36 to be adjusted parallel to the feed mechanism 14. An adjustment in the direction parallel to the direction 68 produces a displacement of the position of the magazine 20 in the direction of the center point 26 of the feed mechanism 14 or in the opposite direction thereto.

The storage device 18 is fixed by means of a fixing mechanism 78 on the carrier 56 and/or on the guiding rail 58 of the guiding mechanism 54. The fixing mechanism 78 is configured, for example, in the form of a spring-loaded sphere, which is arranged on a guiding element 60. A sphere of this type engages, for example, in a recess configured on the carrier 56 or on the guiding rail 58, so that a locking device can be formed altogether, by means of which the feed mechanism 18 can be fixed detachably in its home position shown in the drawing. The feed mechanism 18 can be led out of this home position by overcoming the release resistance of the fixing mechanism 78 in the direction 80 corresponding to the driving direction 24 of the feed mechanism 14.

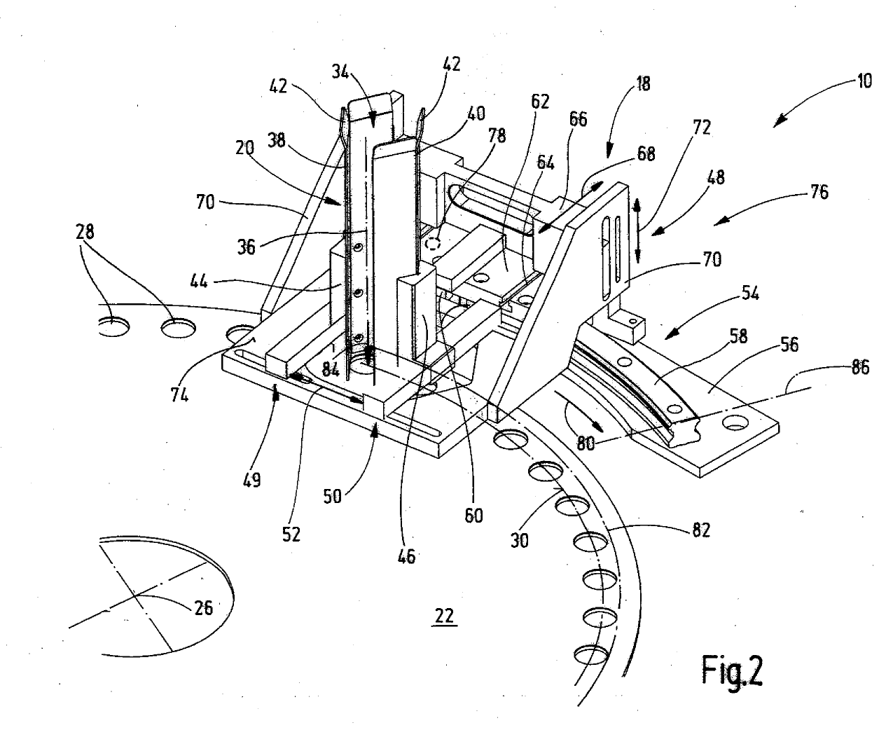

The storage device 18 and thus the magazine 20 can be moved along a magazine motion path 82 by means of the guiding mechanism 54. The magazine motion path 82 is predetermined by means of the course of the guiding rail 58. The curvature center point of the guiding rail 58 coincides with the center point 26 of the feed mechanism 14. Thus, the magazine motion path 82 runs parallel to the workpiece motion path 30. If a workpiece 16 accommodated in the magazine chamber 34 reaches a position wherein it overlaps a holding area 28 of the feed mechanism 14 when the feed mechanism 14 is rotating, the workpiece 16 falls into the holding area 28 running in a transverse feeding direction 84 relative to the workpiece motion path 30. In case a workpiece 16 is not completely discharged from the magazine chamber 34, while the storage device 18 is located in its home position, a workpiece of this type may become jammed with the holding area 28 and with the lower edge of the magazine walls 38, 40. Since the feed mechanism 14 continues rotating, a jammed workpiece 16 exerts a force on a magazine wall 40 following the feed direction 14 in the driving direction 24 that starts at the holding area 28. If this force exceeds the release resistance of the fixing mechanism 78, the storage device 18 is moved in a direction 80 in the direction of the end position (indicated in FIG. 2 with a dashed line 86). Thus, the destruction of a holding area 28 and/or of a jammed workpiece 16 and/or of a magazine wall 38, 40 of the magazine 20 can be prevented. Aside from this, it is not necessary to stop the feed mechanism 14, so that a further workpiece 16, which is engaged with the tool 12, can be further machined.

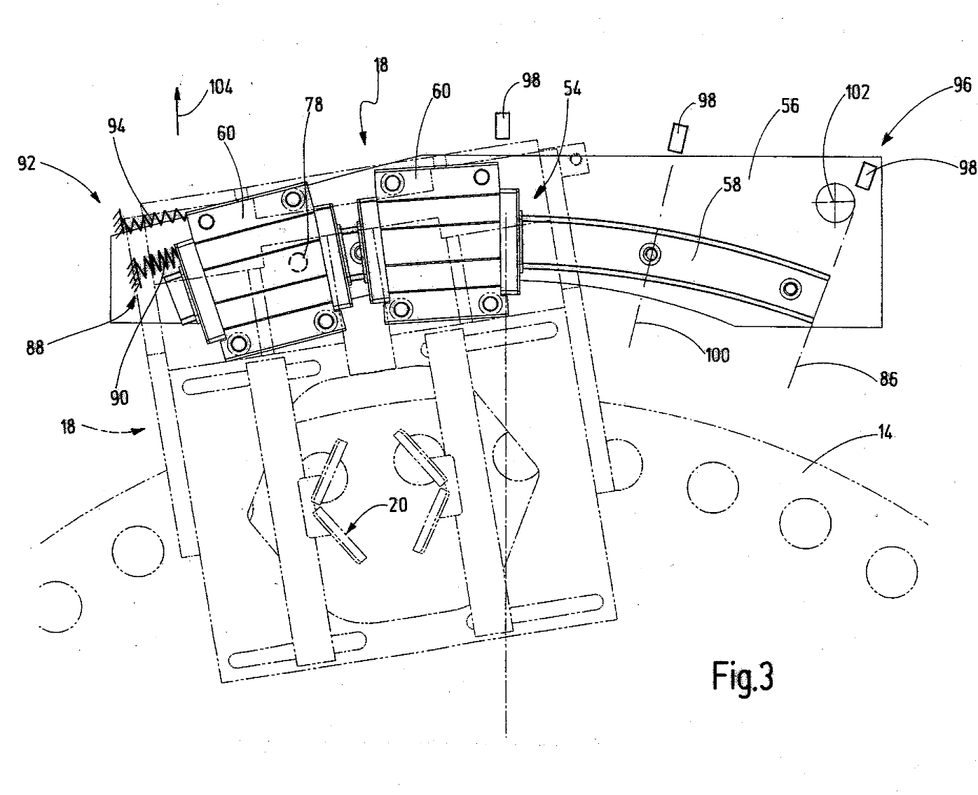

It is possible to support the motion of the feed mechanism 18 out of the home position by means of a forward drive mechanism 88 (which is shown in FIG. 3), so that the feed mechanism 18 can be accelerated out of the home position in the direction of the end position 86. The forward drive mechanism is formed, for example, by a pressure spring 90, which is braced on the fixed carrier 56.

It is also possible to transfer a feed mechanism moved out of the home position back to the home position by means of a reverse drive mechanism 92. A tension spring 94, which connects the storage device 18 to the fixed carrier 56, can be utilized, for example, for this purpose.

A detection device 96 can be provided which comprises sensors 98, for example, to each of which different positions of the storage device 18 are assigned. The detection device 96 comprises, for example, position sensors, to each of which the home position, an intermediate position (indicated in FIG. 3 with the dashed line 100), and the end position 86 are assigned.

The detection device 96 is coupled to a control device for controlling the drive of the feed mechanism 14. If it is detected, for example, that the storage device 18 has left its home position and/or the storage device 18 has reached the intermediate position 100, the drive of the feed mechanism 14 can be actuated such that the feed mechanism 14 stays within the available stopping distance until it reaches the end position 86.

The fixed carrier 56 can preferably be pivoted around a supporting point 102, so that the carrier is pivoted away together with the guiding rail 58, and the storage device 18 can correspondingly be pivoted away from the feed mechanism 14 to a pivoting direction 104. This facilitates the access to the feed mechanism 14 for maintenance purposes and/or for exchanging the feed mechanism 14.

The radius of the guiding rail 58 measures, for example, between approximately 40 cm and approximately 80 cm, in particular approximately 60 cm. The workpieces that can be accommodated in the magazine 20 can be disk-shaped, for example, and have a diameter of, for example, 30 mm to approximately 150 mm. The distance between the lower edge of the magazine walls 38, 40 and the surface of the feed mechanism 14 facing the magazine 20 can, for example, be approximately max. 30 mm. The path available for the motion of the storage device 18 between its home position and the end position 86 covers, for example, an angular sector of approximately 20° to approximately 35°, in particular approximately 25° to approximately 30°, relative to the center point 26.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A device for precision machining or micromachining workpieces, with a feed mechanism for transporting at least one workpiece, with a storage device, which comprises a magazine for storing at least one workpiece, and with a tool for processing at least one workpiece, wherein the at least one workpiece can be led out of the storage device magazine to the feed mechanism, wherein the feed mechanism can be moved such that a workpiece held on the feed mechanism can be transported to the tool, wherein the storage device magazine can be moved along a magazine motion path, whose course is aligned at least in part with a workpiece motion path, which is traversed by a workpiece held on the feed mechanism during the transport from the storage device magazine to the tool.

2. The device of claim 1, wherein the magazine motion path and the workpiece motion path have at least approximately parallel direction components relative to one another.

3. The device of claim 1 wherein the magazine motion path and the workpiece motion path run at least approximately parallel relative to one another.

4. The device of claim 1, wherein the magazine motion path and the workpiece motion path are each curved.

5. The device of claim 1, further comprising an adjusting mechanism for adjustment of the position of the magazine relative to the feed mechanism.

6. The device of claim 1, wherein the feed mechanism is configured in the form of a feed plate.

7. The device of claim 1, wherein at least one tool is a grinding tool or a machining tool.

8. The device of claim 1, wherein the workpiece has a feeding direction from the magazine to the feed mechanism that runs transversely to the workpiece motion path.

9. The device of claim 1 wherein the storage device can be moved between a home position and an end position.

10. The device of claim 9, further comprising a forward drive mechanism for driving the storage device in the direction of the end position.

11. The device of 9, further comprising a fixing mechanism, by means of which the storage device can be fixed detachably in the home position.

12. The device of claim 9, further comprising a reverse drive mechanism for driving the storage device in the direction of the home position.

13. The device of claim 1, further comprising a detection device for detecting a position or a motion of the storage device.

14. The device of claim 1, wherein the magazine motion path and the workpiece motion path are each curved and have a common center of curvature.

15. The device of claim 1, further comprising a guiding mechanism for guiding the magazine along the magazine motion path.
